(19) United States
(12) Patent Application Publication
(10) Pub. No.: US 2025/0263101 A1
(43) Pub. Date: Aug. 21, 2025

(54) RETRACTABLE TUBE MECHANISM AND STROLLER

(71) Applicant: WONDERLAND SWITZERLAND AG, Steinhausen (CH)

(72) Inventors: Haibo ZENG, Dongguan (CN); Xiaojian ZHANG, Dongguan (CN)

(21) Appl. No.: 18/859,860

(22) PCT Filed: Apr. 25, 2023
(86) PCT No.: PCT/EP2023/060825

§ 371 Date: Oct. 24, 2024

(30) Foreign Application Priority Data
Apr. 25, 2022 (CN) 202210443174.X

(51) Int. Cl. B62B 5/06; B62B 9/20

(52) U.S. Cl. CPC B62B 5/065; B62B 9/20

(57) ABSTRACT

The present application discloses a retractable tube mechanism and a stroller. The retractable tube mechanism includes: an outer tube; an inner tube inserted into the outer tube and axially movable relative to the outer tube; and a locking device including a locking member and a pulling member both arranged in the inner tube. The locking member is operably connected to the pulling member. The locking member has a locked state in which an axial movement of the inner tube relative to the outer tube is restrained, and an unlocked state in which the axial movement of the inner tube is allowed. When the pulling member moves under the action of a pulling force, the pulling member drives the locking member to switch from the locked state to the unlocked state. When the pulling force is removed, the locking member tends to return from the unlocked state to the locked state.

### CROSS REFERENCE TO RELATED APPLICATION

This application is the national phase under 35 U.S.C. § 371 of PCT International Application No. PCT/EP2023/060825, which has an international filing date of Apr. 25, 2023, and claims priority of Chinese patent application No. 202210443174.X filed on Apr. 25, 2022. The contents of the above identified PCT international application and Chinese patent application are hereby incorporated in their entireties by reference for all purposes.

### DESCRIPTION

The present application relates to a retractable tube mechanism and a stroller.

Strollers can provide convenience for parents to carry infants and young children out. The stroller is provided with a handle for the parent to push. Usually, the handle is manufactured to have a height according to the average height of adults, which is not friendly to the parent who have a height less than the average height or greater than the average height.

An object of the present application is to provide a retractable tube mechanism, so that users can adjust the length of a tube as needed. For the tube arranged inclinedly, adjusting the length of the tube can change the height of the tube from the ground. The present application further provides a stroller with the retractable tube mechanism.

In an aspect, the present application provides a retractable tube mechanism. The retractable tube mechanism includes: an outer tube; an inner tube inserted into the outer tube and axially movable relative to the outer tube; and a locking device including a locking member and a pulling member both arranged in the inner tube. The locking member is operably connected to the pulling member. The locking member has a locked state in which an axial movement of the inner tube relative to the outer tube is restrained, and an unlocked state in which the axial movement of the inner tube is allowed. When the pulling member moves under the action of a pulling force, the pulling member drives the locking member to switch from the locked state to the unlocked state. When the pulling force is removed, the locking member tends to return from the unlocked state to the locked state.

Further, an inner wall of the outer tube is arranged with a rack extending in an axial direction. The locking member includes a gear supported by the inner tube. The gear is meshed with the rack through an opening on a tube wall of the inner tube. The locking member further includes a locking fork. The locking fork is connected to the pulling member. When the pulling force is removed, the locking fork is jointed to the gear, to restrain rotation of the gear; and when the pulling force is applied, the locking fork is driven by the pulling member to disjoint from the gear, thereby allowing the gear to rotate.

Further, the locking fork includes an engagement portion. The locking fork restrains the rotation of the gear by engagement of the engagement portion with the gear.

Further, the locking fork is adapted to move along an axial direction of the inner tube, so that the engagement portion is engaged with the gear or disengaged from the gear.

Further, the locking fork is arranged with a first guide hole and a second guide hole spaced from the first guide hole. The engagement portion is positioned between the first guide hole and the second guide hole. A central shaft of the gear extends through the first guide hole. A pin shaft extends through the second guide hole. The pin shaft is fixed to the inner tube.

Further, the locking device further includes a first elastic member. The first elastic member is configured to maintain the engagement of the engagement portion with the gear. A first end of the pulling member is connected to the locking fork, and a second end of the pulling member is an operating end.

Further, the first elastic member includes a first spring. The first spring is sleeved on the locking fork. A first end of the first spring is adjacent to the central shaft, and is limited by a limiting step on the locking fork; and a second end of the first spring is limited by the pin shaft.

Further, the locking fork includes a shank, and a U-shaped structure positioned at an end of the shank. The engagement portion is arranged on a base wall of the U-shaped structure. Another end of the shank is connected to the pulling member. The gear is positioned in the U-shaped structure. The first guide hole is arranged in each of two opposite sidewalls of the U-shaped structure. The second guide hole is arranged in the shank.

Further, the locking fork is pivotally connected to the inner tube through a pivot. The locking fork is adapted to rotate around the pivot, so that the engagement portion is engaged with the gear or disengaged from the gear.

Further, the engagement portion includes at least one protruding tooth. The at least one protruding tooth is adapted to be engaged with a teeth portion of the gear.

Further, a plurality of protruding portions are arranged on at least one end surface of the gear at intervals in a circumferential direction. A locked position is formed between every two adjacent protruding portions. The engagement portion is adapted to be inserted into the locked position to be engaged with the gear.

Further, the outer tube is provided with at least two positioning holes in an axial direction. The locking member includes a base portion and a pin portion connected to the base portion. The locking device further includes a blocking member, a second elastic member, and a third elastic member all arranged in the inner tube. The blocking member is connected to a first end of the pulling member. A second end of the pulling member is an operating end. The blocking member is adapted to be driven by the second elastic member or the pulling force to move to a locked position or an unlocked position in an axial direction of the inner tube. When the blocking member moves toward the locked position, the base portion is driven by the blocking member to move in a first radial direction of the inner tube, so that the pin portion is inserted into the corresponding positioning hole; when the blocking member moves toward the unlocked position, the base portion is driven by the third elastic member to move in a second radial direction of the inner tube, so that the pin portion is withdrawn from the corresponding positioning hole.

Further, the base portion is provided with a first pushing portion. The locking member is provided with a second pushing portion adapted to abut against the first pushing portion. At least one of the first pushing portion and the second pushing portion is a slope. When the first pushing portion abuts against the second pushing portion, a direction of a radial force applied by the second elastic member on the base portion is opposite to a direction of a radial force applied by the third elastic member on the base portion. The radial force applied by the second elastic member on the base portion is greater than the radial force applied by the third elastic member on the base portion.

Further, the base portion includes a first top portion connected to the first pushing portion. The blocking member includes a second top portion connected to the second pushing portion. At least one of the first top portion and the second top portion is planar. When the blocking member is at the locked position, the second top portion abuts against the first top portion.

Further, when the blocking member is at the locked position, the blocking member includes a portion interposed between a wall of the inner tube and the base portion. The portion restrains the pin portion from being withdrawn from the corresponding positioning hole.

Further, the locking device further includes a fixing member mounted in the inner tube. The blocking member is slidably fitted with the fixing member. The second elastic member is arranged between the blocking member and the fixing member. The base portion is slidably fitted with the fixing member. The third elastic member is arranged between the base portion and the fixing member.

Further, the fixing member includes a receiving portion. A base wall of the receiving portion is provided with a first through hole. A tube wall of the inner tube is provided with a second through hole. A sidewall of the base portion is slidably fitted with a sidewall of the receiving portion. The pin portion is slidably fitted with the first through hole and the second through hole. The third elastic member is interposed between the base wall of the receiving portion and the base portion.

Further, the fixing member includes a first baffle; the blocking member includes a second baffle. The first baffle and the second baffle face each other, and are spaced from each other in the axial direction of the inner tube. The second elastic member is interposed between the first baffle and the second baffle.

Further, the base portion and the pin portion are integrally formed by injection molding or overmolding.

Further, a first end of the pulling member is operably connected to the locking member, and a second end of the pulling member is an operating end. The second end of the pulling member is connected to a driving member arranged in the inner tube. A first operating member is mounted on the inner tube. The first operating member is operably connected to the driving member. When being subjected to a force, the first operating member is adapted to drive the driving member to move, thereby applying the pulling force to the pulling member. Or, the second end of the pulling member is connected to a second operating member that is sleeved on the inner tube. The second operating member is adapted to move along the inner tube when being subjected to a force, so as to apply the pulling force to the pulling member.

Further, the first operating member is provided with a first guide slope. The driving member is provided with a second guide slope. The second guide slope is kept in cooperation with the first guide slope.

In another aspect, the present application provides a stroller. The stroller is provided with the retractable tube mechanism as described above. The outer tube is a frame tube of the stroller; and the inner tube is retractable handle tube.

In the retractable tube mechanism according to the present application, by applying or removing the pulling force to the pulling member, the locking member can be switched between the unlocked state and the locked state. When the locking member is switched to the unlocked state, the axial position of the inner tube relative to the outer tube can be adjusted. When the inner tube is adjusted to a proper position, the locking member can be switched to the locked state, and the locking member locks the axial position of the inner tube relative to the outer tube.

### BRIEF DESCRIPTION OF THE DRAWINGS

FIG. 1 is a perspective view schematically showing a stroller according to an embodiment of the present application.

FIG. 2 is a partial cross-sectional view schematically showing a retractable tube mechanism according to a first embodiment of the present application, where a locking member is in a locked state.

FIG. 3 is a partial cross-sectional view schematically showing the retractable tube mechanism according to the first embodiment of the present application, where the locking member is in an unlocked state.

FIG. 4 is a perspective exploded view schematically showing a locking device of the retractable tube mechanism according to the first embodiment of the present application.

FIG. 5 is a perspective view schematically showing the locking device of the retractable tube mechanism according to the first embodiment of the present application.

FIG. 6 is a side view schematically showing partial structure of a retractable tube mechanism according to a second embodiment of the present application, where a locking member is in an unlocked state.

FIG. 7 is a perspective view schematically showing a stroller according to another embodiment of the present application.

FIG. 8 is a cross-sectional view schematically showing a retractable tube mechanism according to a third embodiment of the present application, where a locking member is in a locked state.

FIG. 9 is a cross-sectional view schematically showing the retractable tube mechanism according to the third embodiment of the present application, where a locking member is in an unlocked state.

FIG. 10 is a perspective exploded view schematically showing a locking device of the retractable tube mechanism according to the third embodiment of the present application, from a perspective.

FIG. 11 is a side view schematically showing the locking device and a second operating member of the retractable tube mechanism according to the third embodiment of the present application, where the locking device is in a locked state.

FIG. 12 is a side view schematically showing the locking device and the second operating member of the retractable tube mechanism according to the third embodiment of the present application, where the locking device is in an unlocked state.

FIG. 13 is a perspective exploded view schematically showing the locking device of the retractable tube mechanism according to the third embodiment of the present application, from another perspective different than FIG. 10.

FIG. 14 is a cross-sectional view schematically showing a retractable tube mechanism according to a fourth embodiment of the present application, where a locking member is in a locked state.

### DETAILED DESCRIPTION OF THE EMBODIMENTS

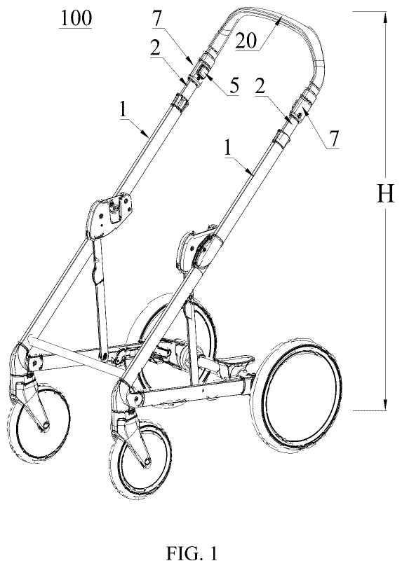

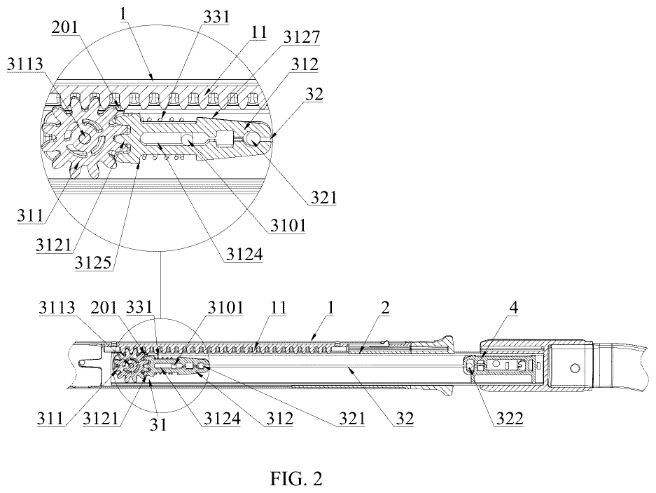

FIGS. 2 to 5 show a structure of a retractable tube mechanism according to a first embodiment of the present application. FIG. 1 shows a stroller 100 according to the embodiment of the present application. The retractable tube mechanism according to the first embodiment of the present application is applied in the stroller 100. Specifically, the retractable tube mechanism is applied between a frame tube (an outer tube 1) and a retractable handle tube (an inner tube 2) of the stroller 100, so that the retractable handle tube can be extended and retracted relative to the frame tube, such that a height H of a handle 20 connected to the retractable handle tube can be changed to meet different requirements of the parents of different heights for the height of the handle.

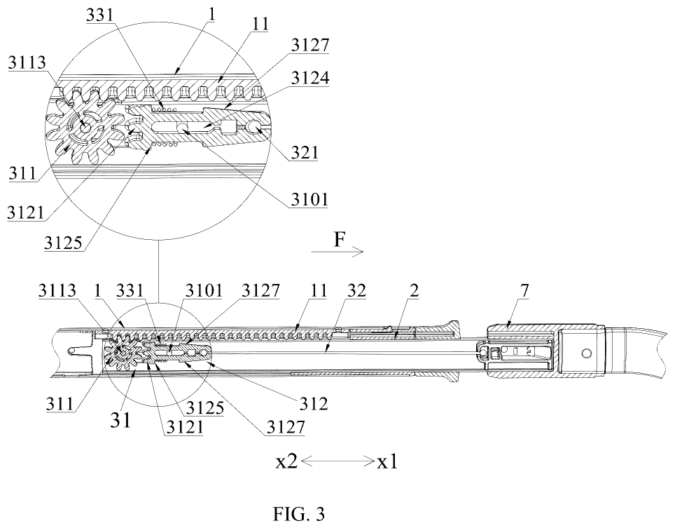

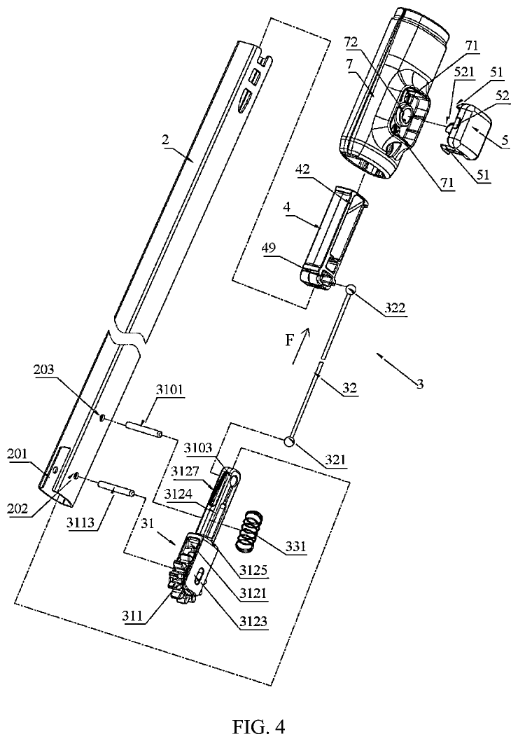

The retractable tube mechanism according to the first embodiment of the present application will be described in detail below. Referring to FIGS. 2 and 4, the retractable tube mechanism may include an outer tube 1, an inner tube 2, and a locking device 3. The inner tube 2 is inserted in the outer tube 1 and axially movable relative to the outer tube 1. The locking device 3 includes a locking member 31 and a pulling member 32 both arranged in the inner tube 2. The locking member 31 is operably connected to the pulling member 32. The locking member 31 is in a locked state under normal conditions, to restrain an axial movement of the inner tube 2 relative to the outer tube 1, and lock an axial position of the inner tube 2 relative to the outer tube 1. Referring to FIG. 3, when it is necessary to adjust the axial position of the inner tube 2 relative to the outer tube 1, a pulling force F can be applied to the puling member 32, so that the pulling member 32 moves under the action of the pulling force F, while driving the locking member 31 to switch from the locked state to an unlocked state. The locking member 31 in the unlocked state allows the inner tube 2 to move axially relative to the outer tube 1. When the inner tube 2 moves to a proper position, the pulling force F is removed, and the locking member 31 tends to return from the unlocked state to the locked state. When the locking member 31 returns to the locked state, the inner tube 2 is locked at an adjusted axial position. When the retractable tube mechanism is used in a stroller, a parent can adjust an extension length of the inner tube 2 relative to the outer tube 1 according to their actual needs, so that the handle 20 is positioned at a suitable height H, which is convenient for the parent to push and pull the stroller.

Referring to FIGS. 2 to 4, in this embodiment, an inner wall of the outer tube 1 may be arranged with a rack 11 extending in an axial direction. The rack 11 may be fixed on the inner wall of the outer tube 1 by fasteners (not shown), for example. The locking member 31 can also include a gear 311 arranged in the inner tube 2 and supported by the inner tube 2. A central shaft 3113 of the gear 311 can be fixed in a positioning hole 202 of the inner tube 2. The gear 311 is meshed with the rack 11 through an opening 201 on a tube wall of the inner tube 2.

Continuing to refer to FIGS. 2 to 4, the locking member 31 may further include a locking fork 312. The locking fork 312 is connected to the pulling member 32. When the pulling force F is removed, the locking fork 312 is jointed to (for example, engaged with, as described below) the gear 311, to limit the rotation of the gear 311, so that the gear 311 cannot move along the rack 11, thereby locking the axial position of the inner tube 2 relative to the outer tube 1. It can be understood that the locking fork 312 being jointed to the gear 311 corresponds to the locked state of the locking member 31. When the pulling force F is applied, the pulling member 32 can drive the locking fork 312 to disjoint from the gear 311, thereby allowing the gear 311 to rotate, so that the gear 311 can move along the rack 11, thereby adjusting the axial position of the inner tube 2 relative to the outer tube 1. It can be understood that the locking fork 312 being disjointed from the gear 311 corresponds to the unlocked state of the locking member 31. In this embodiment, the meshing fit between the rack 11 and the gear 311 can provide enough adjustable positions for the inner tube 2, which can improve the user experience. In addition, during the moving process of the inner tube 2, the tightly meshed rack 11 and gear 311 will not generate a large impact noise, and can also prevent the inner tube 2 from swinging when sliding up and down relative to the outer tube 1.

Referring to FIGS. 2 and 3, the locking fork 312 may include an engagement portion 3121. The locking fork 312 restrains the rotation of the gear 311 by engagement of the engagement portion 3121 with the gear 311. The locking device 3 may further include a first elastic member 331. The engaging state of the engagement portion 3121 with the gear 311 is maintained by the first elastic member 331. A first end 321 of the pulling member 32 is connected to the locking fork 312, and a second end 322 of the pulling member 32 is an operating end. A user can apply the pulling force F to the pulling member 32 by operating the second end 322 of the pulling member 32, to drive the engagement portion 3121 to disengage from the gear 311 through the pulling member 32. It can be understood that when the pulling force F is removed, the engagement portion 3121 can return to the state of being engaged with the gear 311 driven by the first elastic member 331.

It can be seen from FIGS. 2 and 3 that, in this embodiment, when the locking fork 312 is driven by the pulling member 32 or the first elastic member 331, the locking fork 312 is adapted to move along an axial direction of the inner tube 2, so that the engagement portion 3121 is engaged with the gear 311 or disengaged from the gear 311. More specifically, the pulling member 32 drives the locking fork 312 to move along the axial direction x1 when subjected to the pulling force F, until the engagement portion 3121 is disengaged from the gear 311 (as shown in FIG. 3), and the engagement portion 3121 will not affect the rotation of the gear 311. When the pulling force F is removed, the first elastic member 331 will drive the locking fork 312 to move along an axial direction x2, so that the engagement portion 3121 is engaged with the gear 311 (as shown in FIG. 2). Since the moving direction of the locking fork 312 is limited to the axial direction, after the engagement portion 3121 is engaged with the gear 311, the rotation of the gear 311 is restrained by the engagement portion 3121. The axial movement of the locking fork 312 can be realized in many ways, and some preferred ways are listed below. In addition, a preferred embodiment of the engagement portion 3121 is shown in the figures. The engagement portion 3121 may include one or more protruding teeth. The one or more protruding teeth and part of a teeth portion of the gear 311 may be directly engaged with each other, and in this way, additional modifications to gear 311 are not required.

Referring to FIGS. 2 to 5, this embodiment illustrates a preferred implementation for realizing the axial movement of the locking fork 312. The locking fork 312 can be arranged with a first guide hole 3123 and a second guide hole 3124 spaced from the first guide hole 3123. The first guide hole 3123 and the second guide hole 3124 both extend in the axial direction of the inner tube 2. The engagement portion 3121 is positioned between the first guide hole 3123 and the second guide hole 3124. The central shaft 3113 of the gear 311 extends through the first guide hole 3123, and the central shaft 3113 is slidably fitted with the first guide hole 3123. A pin shaft 3101 extends through the second guide hole 3124. The pin shaft 3101 is slidably fitted with the second guide hole 3124. Both ends of the pin shaft 3101 are fixed in a positioning hole 203 of the inner tube 2. In this way, the locking fork 312 can slide smoothly in the axial direction of the inner tube 2 by utilizing the sliding fit between the central shaft 3113 and the first guide hole 3123 and the sliding fit between the pin shaft 3101 and the second guide hole 3124. In addition to supporting the gear 311, the central shaft 3113 is used to guide the axial movement of the locking fork 312, which also plays a role in simplifying the structure. Certainly, there are many implementations to realize the axial movement of the locking fork 312 in the inner tube 2, and which are not limited to the above embodiments. For example, in some unillustrated embodiments, guide grooves and guide ribs that extends in the axial direction are respectively arranged on the locking fork 312 and the inner tube 2. The guide groove and the guide rib are slidably fitted with each other, to guide the axial movement of the locking fork.

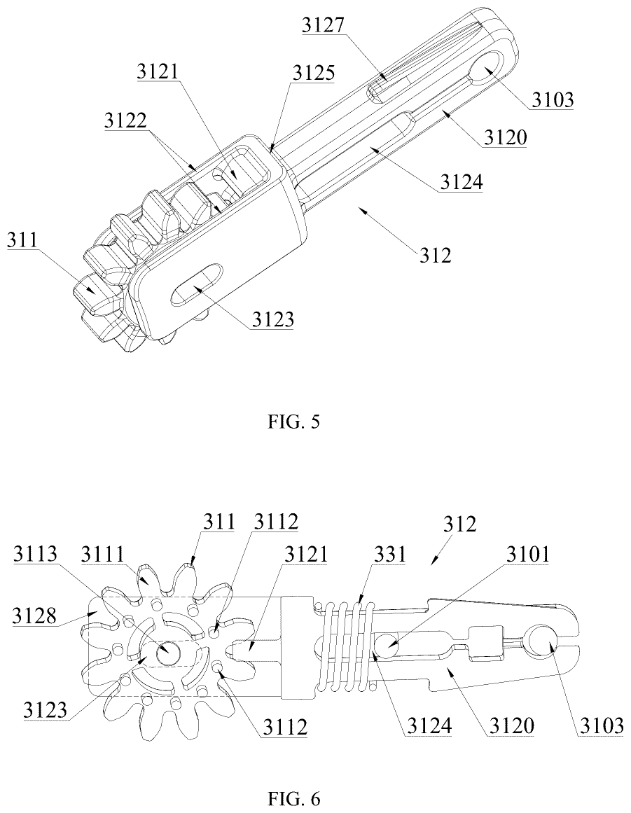

Referring to FIG. 5 below, a preferred structure of locking fork 312 is illustrated in this embodiment. The locking fork 312 can include a shank 3120, and a U-shaped structure 3122 that is positioned at an end of the shank 3120. Another end of the shank 3120 is connected to the first end 321 of the pulling member 32. The engagement portion 3121 can be arranged on a base wall (not denoted in the figure) of the U-shaped structure 3122. The first guide hole 3123 may be arranged in each of two opposite sidewalls of the U-shaped structure 3122. The second guide hole 3124 may be arranged in the shank 3120. The gear 311 is positioned in the U-shaped structure 3122. Two ends of the central shaft 3113 extends through the corresponding first guide hole 3123, and then, the central shaft 3113 is fixed in the positioning hole 202. By disposing the U-shaped structure 3122, when a teeth portion of the gear 311 is engaged with the engagement portion 3121, both the gear 311 and the locking fork 312 are in a stable state of force balance.

Referring to FIGS. 2 to 4, this embodiment also illustrates a preferred implementation of the first elastic member 331. The first elastic member 331 may include a first spring, for example, the first spring is sleeved on the locking fork 312. A first end of the first spring is adjacent to the central shaft 3113, and is limited by a limiting step 3125 on the locking fork 312. A second end of the first spring can be limited by the pin shaft 3101. When the pulling member 32 is subjected to the pulling force F, the pulling member 32 pulls the locking fork 312 to move in the axial direction x1, so that the first spring is compressed. When the pulling force F is removed, the first spring pushes the locking fork 312 to move in the axial direction x2, so that the engagement portion 3121 is engaged with the teeth portion of the gear 311, and the pulling member 32 is reset. It can be understood that in other embodiments, the first elastic member 331 can also be implemented in other ways, as long as the first elastic member 331 can drive the locking fork 312 to move so that the engagement portion 3121 is engaged with the gear 311 when the pulling force F is removed. For example, in an unillustrated implementation, the second end of the first spring may not be limited by the central shaft 3113, but radial projections may be arranged on the inner wall of the inner tube 2 to limit the second end of the first spring.

Referring to FIGS. 4 and 5, preferably, one or more wedge-shaped bumps 3127 may be arranged on the shank 3120 of the locking fork 312. As can be seen from FIGS. 2 and 3, the maximum outer diameter of the wedge-shaped bump 3127 is greater than an inner diameter of the first spring (the first elastic member 331). In this way, when the first spring is assembled on the locking fork 312, the first spring can be easily sleeved on the shank 3120 under the guidance of an inclined surface of the wedge-shaped bump 3127, and then, the first spring is limited between the limiting step 3125 and the wedge-shaped bump 3127, which avoid the failure of the function of the first spring due to the first spring sliding to other incorrect positions.

Referring again to FIGS. 4 and 5, this embodiment also illustrates a preferred structure for applying the pulling force F to the pulling member 32. As shown in the figure, the pulling member 32 may be a flexible rope. A first end 321 of the pulling member 32 is connected to a connection position 3103 (for example, a connection hole 3103) on the shank 3120 of the locking fork 31. The second end 322 is connected to a connection position 49 (for example, a connection hole 49) of a driving member 4 arranged in the inner tube 2. Correspondingly, a first operating member 5 is mounted on the inner tube 2. The first operating member 5 is, for example, a button and is operably connected to the driving member 4. When being subjected to a force, the first operating member 5 drives the driving member 4 to move (for example, move axially), thereby applying the pulling force to the pulling member 32. More specifically, a fixed housing 7 can be mounted on the inner tube 2. The fixed housing 7 is provided with a mounting hole 71 and a through hole 72. The first operating member 5 is provided with an elastic arm 51, and a central post 52 with a first guide slope 521. The elastic arm 51 extends through the mounting hole 71 and mounts the first operating member 5 on the fixed housing 7. The central post 52 extends through the through hole 72 and enters the inner tube 2. The driving member 4 is provided with a second guide slope 42. The second guide slope 42 is kept in cooperation with the first guide slope 521. When the first operating member 5 is pressed, the first guide slope 521 pushes the second guide slope 42, so that the driving member 4 moves upward, thereby applying the pulling force F to the pulling member 32, causing the engagement portion 3121 of the locking fork 312 to be disengaged from the gear 311. When the pressing on the first operating member 5 is released, the first elastic member 331 drives the locking fork 312 to return to the state where the engagement portion 3121 is engaged with the gear 311, and in this case, the second guide slope 42 pushes the first guide slope 521, so that the first operating member 5 is reset. It can be understood that the pulling force F can also be applied to the pulling member 32 in many other ways. In some embodiments (refer to the description of the third embodiment below), the pulling member 32 can be a pull rod and integrated with the locking fork 312. A second operating member 6 can be sleeved on the inner tube 2. The second operating member 6 can slide along the inner tube 2 in a preset stroke range. The second end 322 of the pulling member 32 is connected to the second operating member. The second operating member 6 is adapted to move along the inner tube 2 when being subjected to a force, so as to apply the pulling force F to the pulling member 32.

It should be noted that although in this embodiment, the locking fork 312 is moved in the axial direction of the inner tube 2 to realize the engagement of the engagement portion 3121 and the gear 311 or the disengagement of the engagement portion 3121 from the gear 311, in some other embodiments, the locking fork 312 can also be moved in other ways to realize the engagement of the engagement portion 3121 and the gear 311 or the disengagement of the engagement portion 3121 from the gear 311. For example, in some unillustrated embodiments, the locking fork 312 is pivotally connected to the inner tube 2 through a pivot, and the locking fork 312 is adapted to rotate around the pivot, so that the engagement portion 3121 is engaged with the gear 311 or disengaged from the gear 311. The locking fork 312 is held at a position where the engagement portion 3121 thereof is engaged with the gear 311, under the action of the first elastic member (such as a torsion spring), for example. When the pulling member 32 is subjected to the pulling force, the pulling member 32 can drive the locking fork 312 to rotate around the pivot, so that the engagement portion 3121 is disengaged from the gear 311. When the pulling force is removed, the locking fork 312 returns back to the position where the engagement portion 3121 of the locking fork 312 is engaged with the gear 311 under the action of the first elastic member 331.

FIG. 6 shows a partial structure of a retractable tube mechanism according to a second embodiment of the present application. The difference between this embodiment and the above first embodiment mainly lies in the structure of the locking fork 312, and descriptions of the same or similar structures between this embodiment and the above first embodiment will not be repeated herein.

Referring to FIG. 6, the locking fork 312 includes a shank 3120, a side plate 3128 connected to an end of the shank 3120, and a columnar engagement portion 3121. The gear 311 is positioned between the side plate 3128 and the engagement portion 3121. The first guide hole 3123 is arranged on the side plate 3128. The central shaft 3113 of the gear 311 extends through the first guide hole 3123. A plurality of protruding portions 3112 are arranged on an end surface 3111 of the gear 311 at intervals in a circumferential direction. A locked position is formed between every two adjacent protruding portions 3112. When the pulling force F is removed, the engagement portion 3121 is inserted into the locked position to be engaged with the gear 311, thereby limiting the rotation of the gear 311. When the pulling force F is applied to the pulling member 32, the locking fork 312 will move in the axial direction of the inner tube, so that the engagement portion 3121 is disengaged from the gear 311, and thus the gear 311 can rotate.

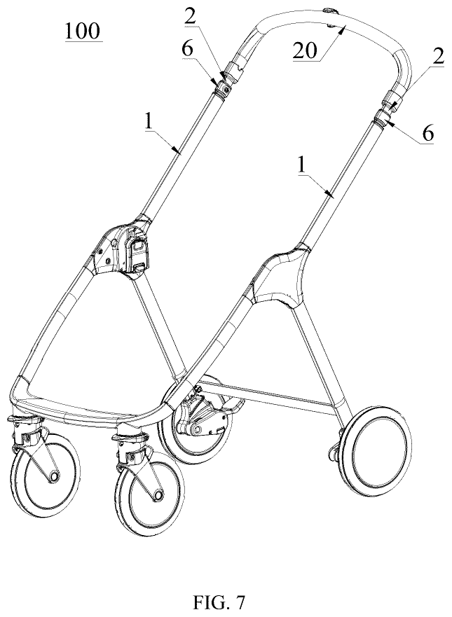

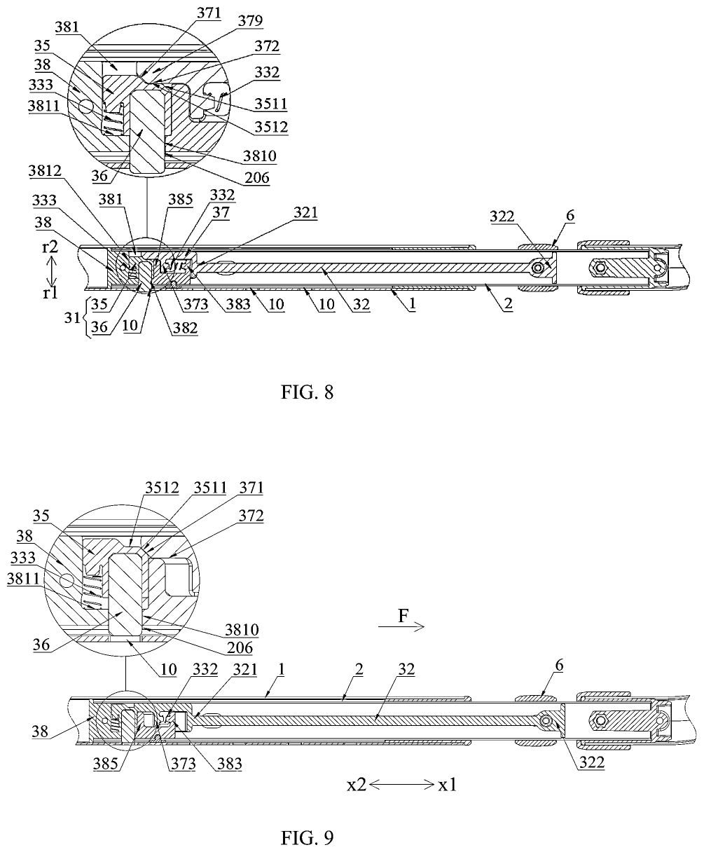

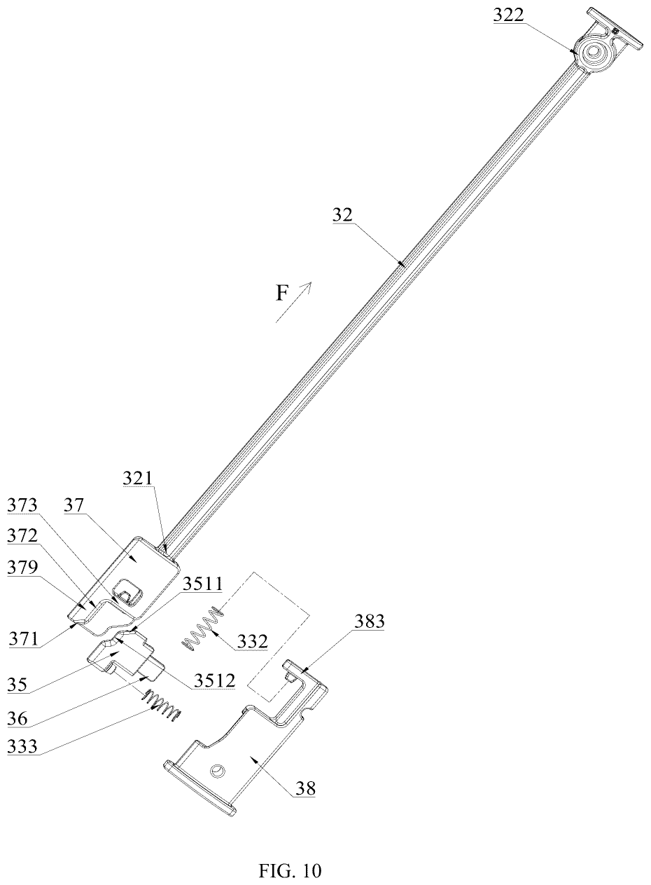

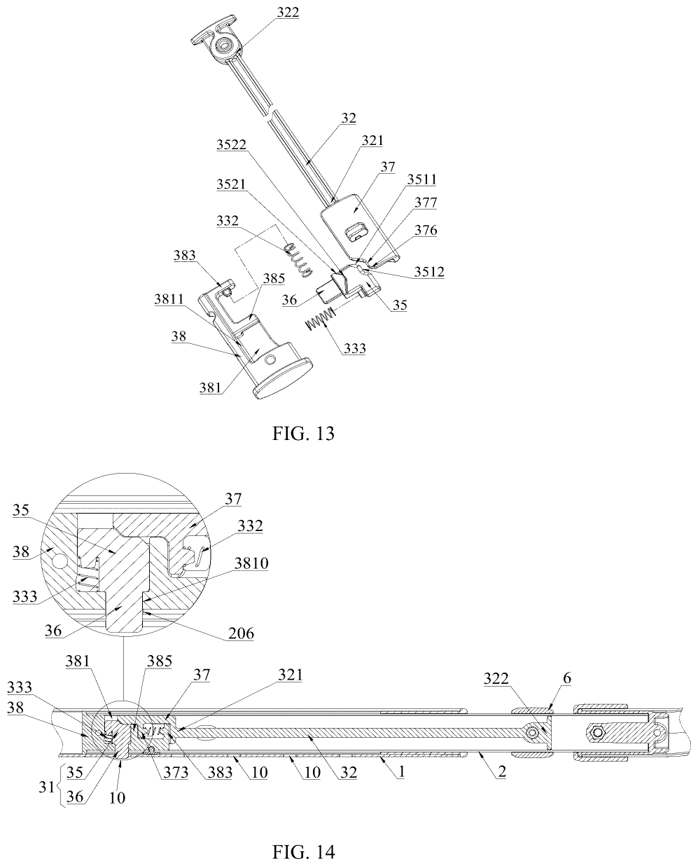

FIGS. 8 to 13 show a structure of a retractable tube mechanism according to a third embodiment of the present application. FIG. 7 shows another stroller 100 according to the embodiment of the present application. The retractable tube mechanism according to the third embodiment of the present application is applied in the stroller 100. As in the aforementioned first embodiment, the height of the handle 20 of the stroller 100 can be adjusted under the action of the retractable tube mechanism.

The retractable tube mechanism according to the third embodiment of the present application will be described in detail below. Referring to FIGS. 8 to 10, in this embodiment, the outer tube 1 is provided with two or more positioning holes 10 in an axial direction. The locking member 31 may include a base portion 35 and a pin portion 36 connected to the base portion 35. The base portion 35 is arranged in the inner tube 2 and can move in the radial direction of the inner tube 2, so that the pin portion 36 is inserted into the corresponding positioning hole 10 or is withdrawn from the corresponding positioning hole 10. It can be understood that when the pin portion 36 is inserted into the positioning hole 10, the locking member 31 is in the locked state, and when the pin portion 36 is withdrawn from the corresponding positioning hole 10, the locking member 31 is in the unlocked state. The base portion 35 and the pin portion 36 may be integrally formed, for example, by overmolding.

Referring to FIGS. 8 and 9, the locking device 3 may further include a blocking member 37, a second elastic member 332, and a third elastic member 333 all arranged in the inner tube 2. The blocking member 37 is connected to the first end 321 of the pulling member 32 and is operably connected to the base portion 35 of the locking member 31. The blocking member 37 has a locked position and an unlocked position. The second end 322 of the pulling member 32 is an operating end, and the user can apply the pulling force F to the pulling member 32 by operating the second end 322 of the pulling member 32. When the pulling member 32 is subjected to the pulling force F, the pulling member 32 will drive the blocking member 37 to move to the unlocked position in the axial direction x1 of the inner tube 2. When the pulling force F on the pulling member 32 is removed, the blocking member 37 is driven by the second elastic member 332 to move toward the locked position in the axial direction x2 of the inner tube 2. During the process of the blocking member 37 moving to the locked position, the base portion 35 is driven by the blocking member 37 to move in a first radial direction r1 of the inner tube 2, so that the pin portion 36 is inserted into the corresponding positioning hole 10. When the blocking member 37 is driven by the pulling force F to overcome the force of the second elastic member 332 and move to the unlocked position, the base portion 35 is driven by the third elastic member 333 to move in a second radial direction r2 of the inner tube 2, so that the pin portion 36 is withdrawn from the corresponding positioning hole 10.

Referring to FIGS. 8 to 13, in order to convert the axial movement of the blocking member 37 into the radial movement of the base portion 35, the base portion 35 may be provided with a first pushing portion (see a first pushing portion 3511, and a first pushing portion 3521 below), the blocking member 37 may be provided with a second pushing portion adapted to abut against the first pushing portion (see a second pushing portion 371, and a second pushing portion 376 below). At least one of the first pushing portion and the second pushing portion is a slope. When the blocking member 37 moves axially, the base portion 35 is driven to move radially by cooperation of the first pushing portion, the second pushing portion, the second elastic member 332, and the third elastic member 333. It can be understood that when the first pushing portion abuts against the second pushing portion, an axial force applied by the second elastic member 332 on the blocking member 37 is converted to a radial force applied to the base portion 35 in the first radial direction r1, through the pushing of the first pushing portion and the pushing of the second pushing portion. A direction of such radial force is opposite to a direction of a radial force applied by the third elastic member 333 on the base portion 35 in the second radial direction r2. The radial force applied by the second elastic member 332 on the base portion 35 is greater than the radial force applied by the third elastic member 333 on the base portion 35, so that when the pulling force F is removed, the second elastic member 332 can overcome the resistance and push the blocking member 37 in the direction of x2, and drives the pin portion 36 together with the base portion 35 to the locked position.

Preferably, in this embodiment, two sets of the first pushing portion and the second pushing portion may be provided. Referring to FIGS. 8 to 10, a set of a first pushing portion 3511 and a second pushing portion 371 are shown. More specifically, the base portion 35 may include the first pushing portion 3511, and a first top portion 3512 connected to the first pushing portion 3511. The blocking member 37 can be provided with the second pushing portion 371, and a second top portion 372 connected to the second pushing portion 371. The first pushing portion 3511 and the second pushing portion 371 can both be slopes. At least one or both of the first top portion 3512 and the second top portion 372 is planar. When the blocking member 37 is driven by the second elastic member 332 to move from the unlocked position to the locked position in the axial direction x2, the second pushing portion 371 pushes the first pushing portion 3511, so that the pin portion 36 is inserted into the corresponding positioning hole 10. When the blocking member 37 is at the locked position, the second pushing portion 371 completely passes over the first pushing portion 3511, so that the second top portion 372 abuts against the first top portion 3512. In this way, even if the pin portion 36 is pressed from the outside of the outer tube 1, the second top portion 372 and the first top portion 3512 will contact each other, and in close contact, so that the pin portion 36 will not be withdrawn from the positioning hole 10, which can effectively avoid accidental unlocking from the inner tube 2.

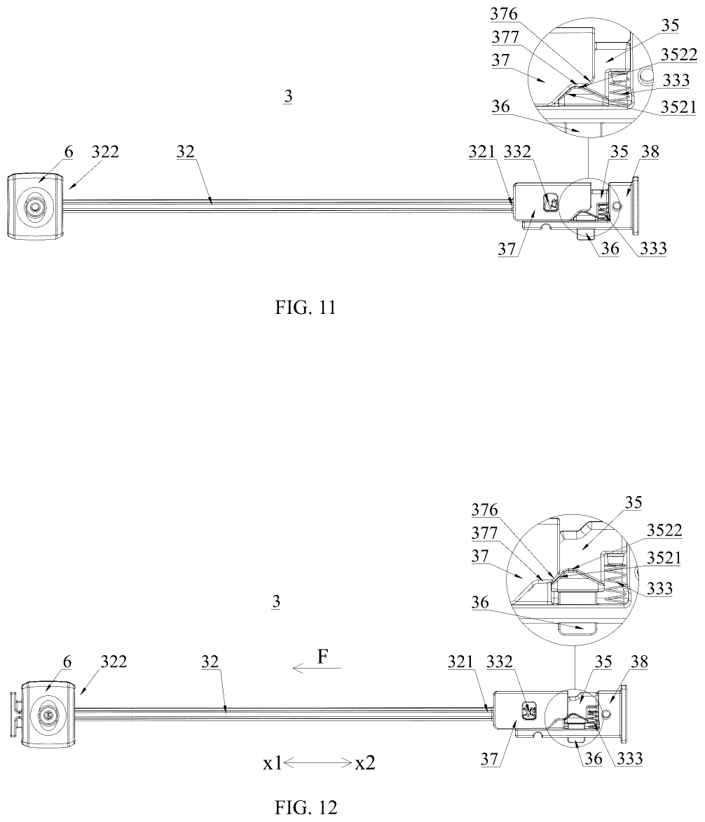

Referring to FIGS. 11 to 13, another set of a first pushing portion 3521 and a second pushing portion 376 is shown. More specifically, the base portion 35 may further include the first pushing portion 3521, and a first top portion 3522 connected to the first pushing portion 3521. The first pushing portion 3521 may be a slope, and the first top portion 3522 may be planar. As can be seen from FIGS. 11 to 13, the blocking member 37 may be provided with the second pushing portion 376, and a second top portion 377 connected to the second pushing portion 376. The second pushing portion 376 may be an arc surface, and the second top portion 377 may be planar. When the blocking member 37 is driven by the second elastic member 332 to move from the unlocked position to the locked position in the axial direction x2, the second pushing portion 376 pushes the first pushing portion 3521, so that the pin portion 36 is inserted into the corresponding positioning hole 10. When the blocking member 37 is at the locked position, the second pushing portion 376 completely passes over the first pushing portion 3521, so that the second top portion 377 abuts against the first top portion 3522 (as shown in FIG. 11). In this way, even if the pin portion 36 is pressed from the outside of the outer tube 1, the pin portion 36 will not be withdrawn from the positioning hole 10, so that the accidental unlocking from the inner tube 2 can be effectively avoided.

Referring to FIG. 8, when the blocking member 37 is at the locked position, the blocking member 37 may include a portion 379 interposed between the wall of the inner tube 2 and the base portion 35. The portion 379 may include the above second top portion 372. On the one hand, this portion 379 limits the pin portion 36 to withdraw from the corresponding positioning hole 10 when being subjected to external pressure. On the other hand, this portion 379 fills a gap between the inner tube 2 and the base portion 35 in the radial direction, which can improve the swing of the inner tube 2 relative to the outer tube 1.

Referring again to FIGS. 8 to 13, in order to facilitate the mounting of the second elastic member 332 and the third elastic member 333, the locking device 3 further includes a fixing member 38 mounted in the inner tube 2. The fixing member 38 is a protruding post mounted on an end of the inner tube 2 for example. The blocking member 37 is slidably fitted with the fixing member 38. The second elastic member 332 is arranged between the blocking member 37 and the fixing member 38. The second elastic member 332 is, for example, a spring arranged in the axial direction of the inner tube 2. The base portion 35 is slidably fitted with the fixing member 3. The third elastic member 333 is arranged between the base portion 35 and the fixing member 38. The third elastic member 333 is, for example, a spring arranged in the axial direction of the inner tube 2. Certainly, the implementations of the second elastic member 332 and the third elastic member 333 are not limited to the above embodiments, and the second elastic member 332 and the third elastic member 333 can have any suitable modification on the basis of meeting their functional requirements.

Referring to FIGS. 8 and 9, preferably, the fixing member 38 may include a receiving portion 381. A base wall 3811 of the receiving portion 381 is provided with a first through hole 3810. The tube wall of the inner tube 2 is provided with a second through hole 206. The first through hole 3810 is in communication with the second through hole 206. A sidewall of the base portion 35 is slidably fitted with a sidewall 3812 of the receiving portion 381. The pin portion 36 is slidably fitted with the first through hole 3810 and the second through hole 206, so that the base portion 35 can move in the radial direction of the inner tube 2, and the pin portion 36 can be inserted into or withdrawn from the positioning hole 10. The third elastic member 333 may be interposed between the base wall 3811 of the receiving portion 381 and the base portion 35. Preferably, the base wall 3811 and/or the base portion 35 may be provided with a protruding post for positioning an end of the third elastic member 333.

Referring to FIG. 9, preferably, the fixing member 38 may include a first baffle 383. The blocking member 37 may include a second baffle 373. The first baffle 383 and the second baffle 373 face each other, and are spaced from each other in the axial direction of the inner tube 2. The second elastic member 332 is interposed between the first baffle 383 and the second baffle 373. Preferably, the first baffle 383 and/or the second baffle 373 may be provided with a protruding post for positioning an end of the second elastic member 332. Preferably, the fixing member 38 may also be provided with a third baffle 385. The third baffle 385 is used to limit the movement of the second baffle 373 in the axial direction x2.

Referring to FIGS. 8 to 9 and 10, this embodiment also illustrates a preferred structure for applying the pulling force F to the pulling member 32. As shown in the figure, the pulling member 32 can be a pull rod, and integrated with the blocking member 37. The second operating member 6 can be sleeved on the inner tube 2. The second operating member 6 can slide along the inner tube 2 in a preset stroke range. The second end 322 of the pulling member 32 is, for example, directly or indirectly connected to the second operating member 6. The second operating member 6 slides along the inner tube 2 in the axial direction x1 when being subjected to a pull force, thereby applying the pulling force F on the pulling member 32. The pulling member 32 drives the blocking member 37 to move to the unlocked position, and the locking member 31 switches to the unlocked state. When the pull force on the second operating member 6 is removed, the second elastic member 332 drives the blocking member 37 to return to the locked position, the locking member 31 switches to the locked state, and the pulling member 32 resets along with the movement of the blocking member 37, and the second operating member 6 resets along with the movement of the pulling member 32. It can be understood that there can be many structures for applying the pulling force F to the pulling member 32. For example, in some alternative embodiments, the structure of the flexible rope and the first operating member 5 described in the first embodiment above can be used.

FIG. 14 shows a partial structure of a retractable tube mechanism according to a fourth embodiment of the present application. The difference between this embodiment and the above third embodiment mainly lies in the structure of the locking member 31, in this embodiment, the base portion 35 and the pin portion 36 are integrally formed by injection molding, for example. It should be noted that regardless of the base portion 35 and the pin portion 36 being integrally formed by overmolding or integrally formed by injection molding, the base portion 35 and the pin portion 36 are contributed to reducing the noise when the inner tube 2 moves relative to the outer tube 1.

Embodiments of the present application further provides a stroller 100. The stroller 100 can be provided with the retractable tube mechanism according to any of the embodiments of the present application, and thus, the height of the handle 20 of the stroller 100 can be adjusted according to the actual needs of the parents. It can be understood that the application scope of the retractable mechanisms for tubes according to the embodiments of the present application is not limited to strollers, and which can also be applied to any other suitable products.

The technical features of the above-described embodiments can be combined arbitrarily. To simplify the description, not all possible combinations of the technical features in the above embodiments are described. However, all of the combinations of these technical features should be considered as being fallen within the scope of the present application, as long as such combinations do not contradict with each other.

The foregoing embodiments merely illustrate some embodiments of the present application, and descriptions thereof are relatively specific and detailed. However, it should not be understood as a limitation to the patent scope of the present application. It should be noted that, a person of ordinary skill in the art may further make some variations and improvements without departing from the concept of the present application, and the variations and improvements falls in the protection scope of the present application. Therefore, the protection scope of the present application shall be subject to the appended claims.

1. A retractable tube mechanism, comprising:
an outer tube;
an inner tube inserted into the outer tube and axially movable relative to the outer tube; and
a locking device comprising a locking member and a pulling member both arranged in the inner tube, the locking member being operably connected to the pulling member;
wherein the locking member has a locked state in which an axial movement of the inner tube relative to the outer tube is restrained, and an unlocked state in which the axial movement of the inner tube is allowed;
wherein when the pulling member moves under the action of a pulling force, the pulling member drives the locking member to switch from the locked state to the unlocked state; and
wherein when the pulling force is removed, the locking member tends to return from the unlocked state to the locked state.

2. The retractable tube mechanism according to claim 1, wherein an inner wall of the outer tube is arranged with a rack extending in an axial direction;
wherein the locking member comprises a gear supported by the inner tube, and the gear is meshed with the rack through an opening on a tube wall of the inner tube;
wherein the locking member further comprises a locking fork connected to the pulling member;
wherein when the pulling force is removed, the locking fork is jointed to the gear, to restrain rotation of the gear, and when the pulling force is applied, the locking fork is driven by the pulling member to disjoint from the gear, thereby allowing the gear to rotate; and
wherein the locking fork comprises an engagement portion, and the locking fork restrains the rotation of the gear by engagement of the engagement portion with the gear rotate.

3. (canceled)

4. The retractable tube mechanism according to claim 2, wherein the locking fork is adapted to move along an axial direction of the inner tube, so that the engagement portion is engaged with the gear or disengaged from the gear.

5. The retractable tube mechanism according to claim 4, wherein the locking fork is arranged with a first guide hole and a second guide hole spaced from the first guide hole, and the engagement portion is positioned between the first guide hole and the second guide hole; and
wherein a central shaft of the gear extends through the first guide hole, a pin shaft extends through the second guide hole, and the pin shaft is fixed to the inner tube.

6. The retractable tube mechanism according to claim 5, wherein the locking device further comprises a first elastic member configured to maintain the engagement of the engagement portion with the gear; and
wherein a first end of the pulling member is connected to the locking fork, and a second end of the pulling member is an operating end.

7. The retractable tube mechanism according to claim 6, wherein the first elastic member comprises a first spring sleeved on the locking fork; and
wherein a first end of the first spring is adjacent to the central shaft, and is limited by a limiting step on the locking fork, and a second end of the first spring is limited by the pin shaft.

8. The retractable tube mechanism according to claim 5, wherein the locking fork comprises a shank, and a U-shaped structure positioned at an end of the shank, the engagement portion is arranged on a base wall of the U-shaped structure, and another end of the shank is connected to the pulling member; and
the gear is positioned in the U-shaped structure, the first guide hole is arranged in each of two opposite sidewalls of the U-shaped structure, and the second guide hole is arranged in the shank.

9. The retractable tube mechanism according to claim 3, wherein the locking fork is pivotally connected to the inner tube through a pivot; and
wherein the locking fork is adapted to rotate around the pivot, so that the engagement portion is engaged with the gear or disengaged from the gear.

10. The retractable tube mechanism according to claim 2,
wherein the engagement portion comprises at least one protruding tooth adapted to be engaged with a teeth portion of the gear; or
wherein a plurality of protruding portions are arranged on at least one end surface of the gear at intervals in a circumferential direction, and wherein a locked position is formed between every two adjacent protruding portions, and the engagement portion is adapted to be inserted into the locked position to be engaged with the gear.

11. (canceled)

12. The retractable tube mechanism according to claim 1, wherein the outer tube is provided with at least two positioning holes in an axial direction;
wherein the locking member comprises a base portion and a pin portion connected to the base portion;
wherein the locking device further comprises a blocking member, a second elastic member, and a third elastic member all arranged in the inner tube;
wherein the blocking member is connected to a first end of the pulling member, and a second end of the pulling member is an operating end;
wherein the blocking member is adapted to be driven by the second elastic member or the pulling force to move to a locked position or an unlocked position in an axial direction of the inner tube;
wherein when the blocking member moves toward the locked position, the base portion is driven by the blocking member to move in a first radial direction of the inner tube, so that the pin portion is inserted into the corresponding positioning hole; and
wherein when the blocking member moves toward the unlocked position, the base portion is driven by the third elastic member to move in a second radial direction of the inner tube, so that the pin portion is withdrawn from the corresponding positioning hole.

13. The retractable tube mechanism according to claim 12, wherein the base portion is provided with a first pushing portion, the locking member is provided with a second pushing portion adapted to abut against the first pushing portion, and at least one of the first pushing portion and the second pushing portion is a slope;
wherein when the first pushing portion abuts against the second pushing portion, a direction of a radial force applied by the second elastic member on the base portion is opposite to a direction of a radial force applied by the third elastic member on the base portion; and
wherein the radial force applied by the second elastic member on the base portion is greater than the radial force applied by the third elastic member on the base portion.

14. The retractable tube mechanism according to claim 13, wherein the base portion comprises a first top portion connected to the first pushing portion, the blocking member comprises a second top portion connected to the second pushing portion, and at least one of the first top portion and the second top portion is planar; and
wherein when the blocking member is at the locked position, the second top portion abuts against the first top portion.

15. The retractable tube mechanism according to claim 12, wherein when the blocking member is at the locked position, the blocking member comprises a portion interposed between a wall of the inner tube and the base portion, and the portion restrains the pin portion from being withdrawn from the corresponding positioning hole.

16. The retractable tube mechanism according to claim 12, wherein the locking device further comprises a fixing member mounted in the inner tube, the blocking member is slidably fitted with the fixing member, the second elastic member is arranged between the blocking member and the fixing member, the base portion is slidably fitted with the fixing member, and the third elastic member is arranged between the base portion and the fixing member.

17. The retractable tube mechanism according to claim 16, wherein the fixing member comprises a receiving portion, and a base wall of the receiving portion is provided with a first through hole, and a tube wall of the inner tube is provided with a second through hole; and
wherein a sidewall of the base portion is slidably fitted with a sidewall of the receiving portion, the pin portion is slidably fitted with the first through hole and the second through hole, and the third elastic member is interposed between the base wall of the receiving portion and the base portion.

18. The retractable tube mechanism according to claim 16, wherein the fixing member comprises a first baffle, the blocking member comprises a second baffle, the first baffle and the second baffle face each other, and are spaced from each other in the axial direction of the inner tube, and the second elastic member is interposed between the first baffle and the second baffle.

19. The retractable tube mechanism according to claim 12, wherein the base portion and the pin portion are integrally formed by injection molding or overmolding.

20. The retractable tube mechanism according to claim 1, wherein a first end of the pulling member is operably connected to the locking member, and a second end of the pulling member is an operating end;
wherein the second end of the pulling member is connected to a driving member arranged in the inner tube, a first operating member is mounted on the inner tube, the first operating member is operably connected to the driving member, and the first operating member is adapted to, when being subjected to a force, drive the driving member to move, so as to apply the pulling force to the pulling member; or
wherein the second end of the pulling member is connected to a second operating member sleeved on the inner tube, and the second operating member is adapted to, when being subjected to a force, move along the inner tube, so as to apply the pulling force to the pulling member.

21. The retractable tube mechanism according to claim 20, wherein the first operating member is provided with a first guide slope; and
wherein the driving member is provided with a second guide slope kept in cooperation with the first guide slope.

22. A stroller, comprising the retractable tube mechanism according to claim 1, wherein the outer tube is a frame tube of the stroller; and the inner tube is a retractable handle tube.
